(19) United States
(12) Patent Application Publication
(10) Pub. No.: US 2012/0120419 A1
(43) Pub. Date: May 17, 2012

(54) IMAGE FORMING APPARATUS AND TONE CORRECTION METHOD OF IMAGE FORMING APPARATUS

(75) Inventor: Kosuke Toura, Tokyo (JP)

(73) Assignee: KONICA MINOLTA BUSINESS TECHNOLOGIES, INC., Tokyo (JP)

(21) Appl. No.: 13/288,538

(22) Filed: Nov. 3, 2011

(30) Foreign Application Priority Data
Nov. 11, 2010 (JP) 2010-252404

(51) Int. Cl. H04N 1/60

(52) U.S. Cl. 358/1.9

(57) ABSTRACT

Disclosed is an image forming apparatus which forms an image on paper, the image forming apparatus including: an image forming section which forms the image on the paper; a correcting section which corrects tone of the image formed by the image forming section; and a control section which manages forming the image on a predetermined number of sheets of paper as print output of one unit, and which allows the correcting section to correct tone each time print output of the predetermined number of units is complete.

### BACKGROUND

1. Field of the Invention

The present invention relates to an image forming apparatus and tone correction method of image forming apparatus.

2. Description of Related Art

In an image forming apparatus of an electro-photographic method such as a laser printer, etc., printing is performed by process of exposure to light, developing, transferring and fixing. Specifically, first in the exposing process, a light exposing beam in which light is modulated based on image data of the print target is emitted to form an electrostatic latent image of the image on a surface of a photoreceptor drum. Here, by modulating the intensity of the light exposing beam or by controlling the light exposure time, concentration of the image, in other words, the tone can be represented. Next, in the developing process, the electrostatic latent image on the photoreceptor drum is developed with the toner and a toner image is formed. In the transferring process, the toner image is transferred by first transfer from the photoreceptor drum to a transfer belt and then transferred by second transfer from the transfer belt to paper. Then, in the fixing process, the paper is heated and the toner image is fixed.

As a color printer which uses toner of a plurality of colors, there is known a color printer of a tandem method where an exposure unit and developing unit are provided for each color, and after toner image of each color is overlapped on a transferring member such as a transfer belt, etc., the toner images are transferred on the paper collectively.

In an image forming apparatus of an electro-photographic method as described above, output density value changes according to variation of characteristic of each apparatus or influence of environment in which the apparatus is used such as temperature, humidity, etc. Therefore, there is a case where a desired output tone which matches input density value cannot be obtained.

In an image forming apparatus described in Japanese Patent Application Laid-Open Publication No. 11-177825, tone correction of the output image is performed.

When print output is performed from an image forming apparatus, print output may be performed in a unit of copies. Print output in a unit of copies is to consider print output on a predetermined number of sheets of paper to be one unit, and print output of the predetermined number of sheets of paper which compose the one unit (one copy) is performed successively. When print output is performed in a unit of copies and print output of a plurality of number of copies is performed, after print output of paper composing one copy is complete, print output composing the next copy is performed.

When print output is performed in a unit of copies, a user usually desires that the print output result of each copy is performed with a similar output density value. However, when print output is performed in a unit of copies using the image forming apparatus as described in Japanese Patent Application Laid-Open Publication No. 11-177825 in which tone correction of the conventional technique is performed, the output density value of one copy when print output is complete before performing tone correction or when tone correction is performed during print output of the copy, may be different from the output density value of one copy of print output right after tone correction. Therefore, there may be a variation in the print output result of each copy, specifically, visual image quality (color, etc.) of a front cover (first page) and the output density value of the print output result may be unstable.

### SUMMARY

The present invention has been made in consideration of the above problems, and it is one of main objects to stabilize output density value of each copy when print output is performed in a unit of copies. Specifically, it is one of main objects to uniform tone and color of a same page among each copy and to reduce variation in image quality and quality among each copy.

In order to achieve at least one of the above-described objects, according to an aspect of the present invention, there is provided an image forming apparatus which forms an image on paper, the image forming apparatus including:

an image forming section which forms the image on the paper;

a correcting section which corrects tone of the image formed by the image forming section; and

a control section which manages forming the image on a predetermined number of sheets of paper as print output of one unit, and which allows the correcting section to correct tone each time print output of the predetermined number of units is complete.

Preferably, in the image forming apparatus,

the predetermined number of units is a number of units in which a number of sheets of paper necessary for print output of the predetermined number of units is a first threshold value or more.

Preferably, in the image forming apparatus,

the control section allows the correcting section to perform tone correction each time print output of one unit is complete when a number of sheets of paper necessary for print output of one unit is less than the first threshold value, and the number of sheets of paper necessary for print output of two units is no less than a second threshold value which is larger than the first threshold value.

Preferably, in the image forming apparatus,

the predetermined number of units is a number of units in which a printed amount necessary for print output of the predetermined number of units is a first printed amount or more.

Preferably, in the image forming apparatus,

the control section allows the correcting section to perform tone correction each time print output of one unit is complete when a printed amount necessary for print output of one unit is less than the first printed amount, and the printed amount necessary for print output of two units is no less than a second threshold value which is larger than the first threshold value.

Preferably, in the image forming apparatus,

the control section allows the correcting section to perform tone correction each time print output of one unit is complete.

Preferably, in the image forming apparatus,

the control section allows the correcting section to perform tone correction when forming of an image on a predetermined number of sheets of paper which is the first threshold value or less is complete during print output of one unit in addition to when print output of one unit is complete in a case where the predetermined number of sheets is a number of sheets of the first threshold value or more.

Preferably, in the image forming apparatus,

the control section allows the correcting section to perform tone correction each time forming of an image on paper of a number of sheets where a predetermined number of sheets which compose one unit is divided evenly to a number of sheets which is the first threshold value or less is complete during print output of one unit.

Preferably, in the image forming apparatus,

the control section allows the correcting section to perform tone correction each time forming of an image on paper of a number of sheets where a predetermined number of sheets which compose one unit is divided evenly to a number of sheets which is the third threshold value or less is complete during print output of one unit.

### BRIEF DESCRIPTION OF THE DRAWINGS

The present invention will become more fully understood from the detailed description given hereinbelow and the appended drawings, and thus are not intended to define the limits of the present invention, and wherein;

FIG. 1 is a cross sectional view of an image forming apparatus 1 of the present embodiment in which the present invention is applied;

FIG. 2 is a diagram showing an inner configuration of a sensor 5;

FIG. 3 is a diagram showing a functional configuration of an image forming apparatus 1;

FIG. 4 is an explanatory diagram showing a relation between difference of output density value while print output advances and timing of tone correction;

FIG. 5 is a flowchart showing a flow of tone correction timing control processing when a second threshold value, third threshold value and second printed amount are not set;

FIG. 6 is a flowchart showing a flow of processing from step S1 to step S5 of the tone correction timing control processing when a second threshold value, third threshold value and second printed amount are set; and

FIG. 7 is a flowchart showing a flow of processing from step S6 to step S10 and step S21 to step S23 of the tone correction timing control processing when a second threshold value, third threshold value and second printed amount are set.

### DETAILED DESCRIPTION OF PREFERRED EMBODIMENTS

Below, an example of an embodiment of the present invention is described in detail with reference to the drawings.

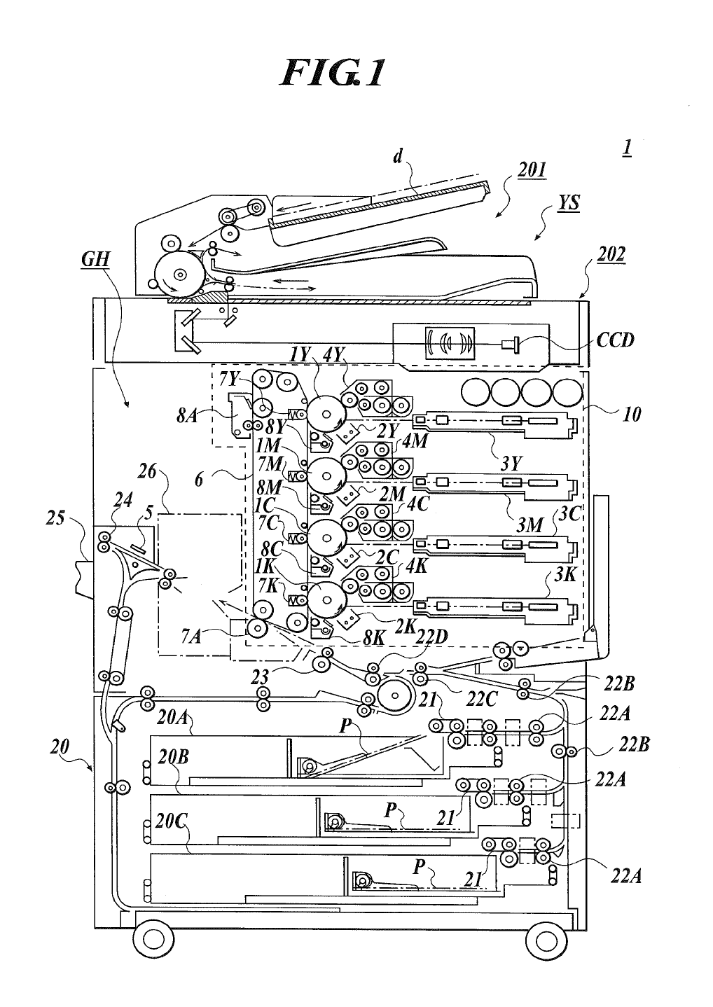

FIG. 1 shows a cross sectional configuration diagram of an image forming apparatus 1 of the present embodiment.

As shown in FIG. 1, the image forming apparatus 1 includes an image forming main body section GH and an image reading section YS.

The image reading section YS is provided on an upper section of the image forming main body section GH and is composed of an automatic document feeding device 201 and a scanning exposing device 202. The automatic document feeding device 201 conveys a document d placed on a document platform with a conveying mechanism and sends out the document d to the scanning exposing device 202. The scanning exposing device 202 scans and exposes with light the conveyed document d and performs photoelectric conversion with the line image sensor CCD to read the document image.

The document image (analog image signal) read by the image reading section YS is output to a later described image processing section. In the image processing section, after various processing such as analog processing, A/D conversion processing, shading processing, image compression processing, etc. are performed, the colors are separated to each color of Y (yellow), M (magenta), C (cyan) and K (black) and output to the image forming section 10 as image data for exposure.

The image forming main body section GH performs image forming with a tandem method and is composed of an image forming section 10 which forms (hereinafter also referred to as print) an image for each color of Y, M, C and K, paper feeding section 20 which feeds paper P, and a fixing section 26 which fixes a toner image formed on the paper P.

The image forming section 10 is composed of exposing sections 3Y, 3M, 3C and 3K which scan a light exposing beam on a photoreceptor drum according to control content of an image processing board 18 (later described) and form a latent image of the image, developing sections 4Y, 4M, 4C and 4K which develop the latent image on the photoreceptor drum with the toner, photoreceptor drums 1Y, 1M, 1C and 1K, charging sections 2Y, 2M, 2C and 2K which are provided around each photoreceptor drum and charge the photoreceptor drums, cleaning sections 8Y, 8M, 8C and 8K which remove residual toner on each photoreceptor drum, a transfer belt 6 which is a transfer member on which the toner image formed on each photoreceptor drum is first transferred, and a cleansing section 8A which removes the residual toner on the transfer belt 6. The transfer belt 6 is rotated by a plurality of rollers and is rotatably supported.

The paper feeding section 20 is composed of paper feeding cassettes 20A, 20B and 20C which contain paper P of various paper sizes and a conveying mechanism including a sending roller 21, paper feeding roller 22A, etc., and conveys the paper P of the specified size to the image forming section 10.

The fixing section 26 is composed of a fixing heater, etc. and performs heat processing on the paper P on which the toner image is transferred and fixes the toner image on the paper P.

The process of image forming by the above described image forming main body section GH is described.

First, exposing sections 3Y, 3M, 3C and 3K perform exposure of light, and the latent image of the image is formed on the photoreceptor drums 1Y, 1M, 1C and 1K based on the input image data for exposure. Next, developing is performed by the developing sections 4Y, 4M, 4C and 4K and the toner image is formed on the photoreceptor drums 1Y, 1M, 1C and 1K. The developing by the developing sections 4Y, 4M, 4C and 4K is performed by a reversal phenomenon in which a developing bias where a direct voltage with a same polarity as the toner polarity used is overlapped with the alternating voltage is applied.

The toner image formed on the photoreceptor drums 1Y, 1M, 1C and 1K are sequentially first transferred on a rotating transfer belt 6 with first transfer rollers 7Y, 7M, 7C and 7K on which first transfer bias of a polarity opposite of the used toner is applied, and a combined color image of toner images of each color is formed on the transfer belt 6.

The paper P is fed from the paper feeding section 20, passes through conveying rollers 22B, 22C, 22D and resist roller 23 and the paper P is conveyed to the second transfer roller 7A. In the second transfer roller 7A, the color image formed on the transfer belt 6 is transferred collectively on one face of the paper P by second transfer. On the paper P on which the second transfer of the color image is performed, fixing processing is performed by the fixing section 26, the paper P is held by a paper ejecting roller 24 and the paper P is ejected outside the apparatus on the paper ejecting tray 25.

After a cycle of the image forming is finished, the toner remaining on the face of the photoreceptor drum 1Y, 1M, 1C and 1K and transfer belt 6 after transfer is removed by the cleaning sections 8Y, 8M, 8C, 8K and 8A, and the processing advances to the next image forming cycle.

Next, the sensor provided in the image forming section 10 is described.

As shown in FIG. 1, a sensor 5 is provided and the sensor 5 measures the reflected light amount from the color image formed on the paper P ejected after the fixing processing. The present embodiment describes an example where the reflected light amount of the image fixed on the paper P ejected after the fixing processing is measured by the sensor 5. However, the invention is not limited to the above, and the reflected light amount of the color image on the paper P before fixing or the image formed on the photoreceptor drum or the transfer belt 6 can be measured. Also, the sensor 5 can be provided in the image reading section YS and the ejected paper P on the paper ejecting tray 25 can be read by the image reading section YS manually so as to be able to perform measurement with the sensor 5.

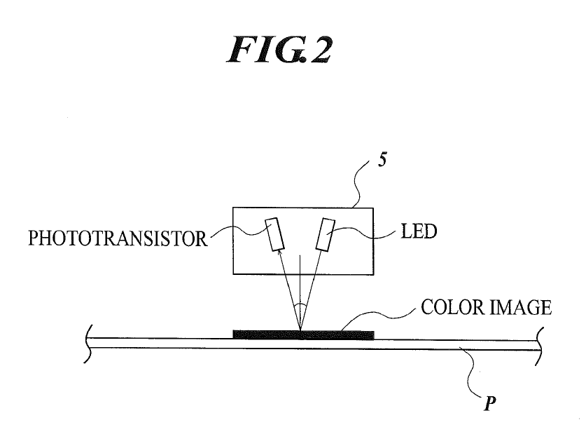

As shown in FIG. 2, the sensor 5 includes a phototransistor and LED (light emitting diode) inside. When measurement is performed, the LED emits light, and when the emitted light is reflected on the color image fixed on the paper P and enters the phototransistor, the reflected light amount (reflected light amount includes various measured elements such as reflectance percentage, light amount, etc.) is measured by the phototransistor. The measured result of the reflected light amount is output to a tone correcting section (later described) of the image forming apparatus 1, the density value is calculated based on the measured result of the reflected light amount by the tone correcting section and the density value is used in tone correction (later described) by the tone correcting section 17. The calculation of the density value is obtained by, for example, log conversion of the measurement value of the reflected light amount, however other methods can also be used.

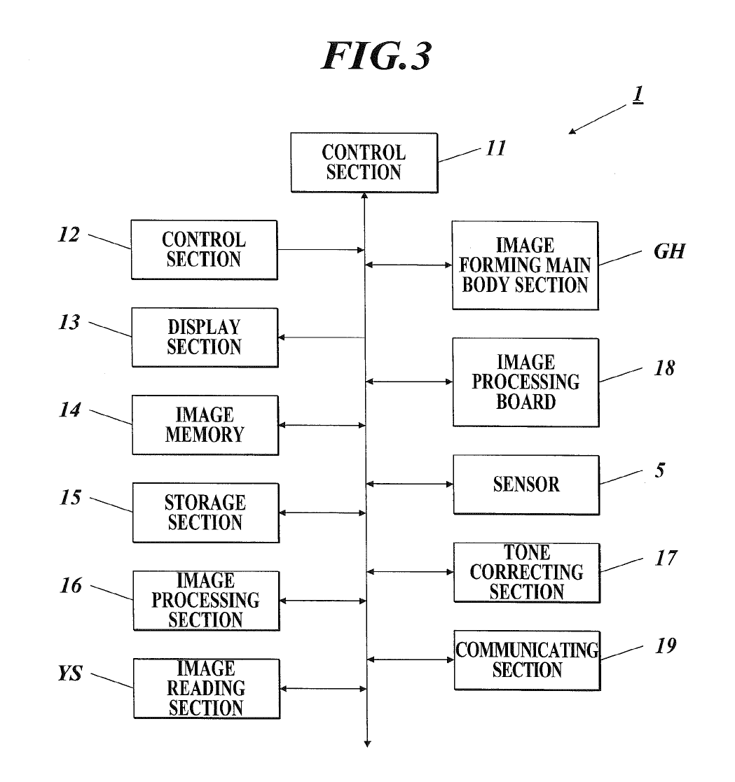

Next, the functional configuration of the image forming apparatus 1 is described with reference to FIG. 3.

As shown in FIG. 3, the image forming apparatus 1 includes a control section 11, an input section 12, a display section 13, an image memory 14, a storage section 15, an image reading section YS, an image forming main body section GH, an image processing section 16, a sensor 5, a tone correcting section 17, an image processing board 18, a communicating section 19, and the like.

The control section 11 is composed of a CPU (Central Processing Unit), etc. and centrally controls operation of each section of the image forming apparatus 1 to perform image forming and tone correction according to an image forming program stored in the storage section 15.

The control section 11 performs control of operation of the tone correction by the tone correcting section 17 (timing control).

The input section 12 includes a numeric key, various function keys, a touch panel configured as one with the display section 13, etc. and outputs to the control section 11 an operation signal corresponding to the operated key and an operation signal according to the input operation on the operation screen displayed on the touch panel.

The display section 13 includes an LCD (Liquid Crystal Display), etc., and displays various operation screens and various display information such as processing results, etc. by the control section 11.

The image memory 14 temporarily stores output target image data such as image data of the document image which is read by the image reading section YS and on which image processing is performed by the image processing section 16.

The storage section 15 includes a magnetic or optic recording medium or semiconductor memory, and in addition to a system program, the storage section 15 stores a tone correction processing program, a timing correction processing program, data processed by the various programs and the like. The storage section 15 stores image data of an image for correcting prepared for each color of Y, M, C and K. The storage section 15 stores data showing various parameter regarding timing control of the tone correction such as a later described predetermined threshold value (first threshold value, second threshold value, third threshold value), a predetermined printed amount (first printed amount, second printed amount), etc.

The image processing section 16 performs various image processing such as analog processing, A/D conversion processing, shading processing, image compression processing, etc. on the document image read by the image reading section YS and outputs the image to the image memory 14.

The image reading section YS, the image forming main body section GH and the sensor 5 are the same as the image reading section YS, the image forming main body section GH, and the sensor 5 described in FIG. 1, and therefore the description is omitted.

In other words, the image reading section YS reads the image of the document placed on the document platform and outputs the document image on the image processing section 16.

The image forming main body section GH forms an image on the specified paper P based on the image data of the document image stored in the image memory 14 according to an instruction from the control section 11.

The sensor 5 emits light on the image for correction formed on the transfer belt 6 and measures the reflected light amount.

The tone correcting section 17 performs tone correction processing to correct change of the output density value with respect to the input density value of the output image. When tone correction processing is performed, image forming of the image for correction for measuring reflected light amount by the sensor 5 is instructed to the image forming section 10. When the image for correction is formed on the paper P, the tone correcting section 17 instructs the start of measurement to the sensor 5. When the measurement of the reflected light amount by the sensor 5 is finished and the measured result of the reflected amount of light is input, the tone correcting section 17 obtains a density value from the measured result of the reflected light amount. The example describes calculating the density value from the measured result of the reflected light amount, however the method is not limited to this, and the brightness or luminosity can be calculated from the measured result of the reflected light amount.

Next, the tone correcting section 17 performs tone correction based on the obtained density value. Specifically, the tone correcting section 17 calculates the measured curve indicating the output density value with respect to the input density value of the image for correction and calculates the tone correction curve including inverse of the measured curve with respect to the target tone. Then, the tone correcting section 17 converts the tone of the output image using the calculated tone correction curve. With this, the tone correction of the output image can be performed. The method of tone correction is one example, and tone correction to obtain the target tone can be obtained by using other methods.

The image processing board 18 controls the operation of the light exposing sections 3Y, 3M, 3C and 3K scanning a light exposing beam on the photoreceptor drum and forming a latent image of the image based on the image data for exposure. The image processing board 18 counts the printed amount of the color image formed on the paper P based on the image data for exposure. The measured result of the printed amount is output to the control section 11.

The communicating section 19 performs communication with external devices. The communicating section 19 includes a communicating device such as a Network Interface Card, (NIC), etc. and performs data transmission with an external device through a line. Data transmission by the communicating section 19 can be wired or wireless and other conditions (for example, standard) regarding connecting method such as protocol are also not limited.

The image forming apparatus 1 is connected to an external device (for example, computer, etc.) through the communicating section 19.

The image forming apparatus 1 includes a function to perform image forming based on data input from an external device. The control section 11 generates image data which is an output target based on data input through the communicating section 19, stores the image data in the image memory 14 and allows the image forming main body section GH to perform image forming. Here, when image data of a plurality of pages is input, the number of sheets of paper on which image forming is performed may be a plurality of pages. Moreover, there may be a specification from an external device which inputs data to the image forming apparatus 1 to perform print output of a plurality of copies of the same content. In this case, the control section 11 obtains the number of sheets of paper which compose one unit, in other words one copy, and the specified number of copies and performs print output in a unit of copies.

When reading of the document image by the image reading section YS is performed using an automatic document feeding device 201, etc., the generated image data may be a plurality of pages. Also, there may be a specification by input operation performed through the input section 12 to perform print output of a plurality of copies of the same content of image data of a plurality of pages. In this case, the control section 11 obtains the number of sheets of paper which compose one copy and the specified number of copies and performs print output in a unit of copies.

Next, the timing control of the tone correction by the control section 11 is described.

First, when the control section 11 performs print output in a unit of copies and performs a plurality of print output, the control section 11 obtains the number of sheets of paper which compose one copy and the number of copies. Then, the control section 11 counts the number of sheets of paper of print output is completed, and after print output of the number of sheets of paper which compose one copy is complete, it is assumed that print output of one copy is complete, and the control section 11 performs print output of the next copy.

When the counted number of sheets of paper which compose one copy is a number of sheets which is a predetermined threshold value (first threshold value) or more, the control section 11 allows the tone correcting section 17 to perform tone correction each time print output of one copy is complete.

The control section 11 obtains the measured result of the printed amount input from the image processing board 18 in print output and counts the printed amount.

Then, when the printed amount in print output of one copy is a predetermined printed amount (first printed amount) or more, the control section 11 allows the tone correcting section 17 to perform tone correction each time print output of one copy is complete.

When at least either one of conditions of the number of sheets of paper composing one copy is a number of sheets of a predetermined threshold value (first threshold value) or more or the printed amount in print output of one copy is a predetermined printed amount (first printed amount) or more is satisfied, the control section 11 allows the tone correcting section 17 to perform tone correction each time print output of one copy is complete.

After tone correction, the control section 11 resets the number of sheets of paper and the printed amount which are counted. What is reset here is the number of sheets of paper and printed amount counted for timing control of the tone correction. The control section 11 separately performs measurement of the number of sheets of paper to manage the number of sheets of paper and the number of copies of print output is completed, and the control section obtains information of the number of copies of print output is complete and the information of the print output complete timing of one copy based on the measurement.

When the number of sheets of paper which compose one copy is less than the predetermined threshold value (first threshold value) and the printed amount in print output of one copy is less than the predetermined printed amount (first printed amount), the control section 11 does not allow the tone correcting section 17 to perform tone correction at the point when the print output of one copy is complete, and allows the image forming apparatus 1 to perform print output of the next copy. When the print output of the next copy is performed, the control section 11 does not reset the number of sheets of paper of print output and printed amount of the previous copy of print output and continues the count. In other words, when the print output of the next copy is complete, the control section 11 counts and holds number of sheets of paper and printed amount regarding print output of two copies.

The control section 11 compares the number of sheets of paper regarding print output of two copies with the first threshold value and when the number of sheets of paper regarding print output of two copies is the first threshold value or more, the control section 11 allows the tone correcting section 17 to perform tone correction when the print output of the two copies is complete. Moreover, the control section 11 compares the printed amount regarding print output of two copies with the first printed amount, and when the printed amount regarding print output of two copies is the first printed amount or more, the control section 11 allows the tone correcting section 17 to perform tone correction when the print output of the two copies is complete. After the tone correction, the control section 11 resets the counted number of sheets of paper and printed amount.

When the number of sheets of paper regarding the print output of two copies is less than the first threshold value and the printed amount regarding the print output of two copies is less than the first printed amount, the control section 11 does not allow the tone correcting section 17 to perform tone correction at the point when the print output of the two copies is complete, and allows the image forming apparatus 1 to perform print output of the next copy. The control section 11 does not reset the number of sheets of paper of print output and printed amount regarding the previous two copies of print output and continues the count. Afterwards, the control section 11 continues print output in a unit of copies until at least either one of the conditions of the number of sheets of paper regarding the print output of the plurality of copies is the first threshold value or more, or the printed amount regarding the print output of the plurality of copies is the first printed amount or more is satisfied. When either one of the conditions is satisfied, at the point when the print output of the copy performing print output when the condition is satisfied is complete, the control section 11 allows the tone correcting section 17 to perform the tone correction before the printing of the next copy is performed. After the tone correction, the control section 11 resets the counted number of sheets of paper and printed amount.

In other words, the control section 11 allows the tone correcting section to perform tone correction each time print output of a predetermined number of copies is complete. The condition of the predetermined number of copies is either the number of copies where the number of sheets of paper necessary for print output of the predetermined number of copies is the first threshold value or more, or the number of copies where the printed amount necessary for the print output of the predetermined number of copies is the first printed amount or more.

As a different embodiment, the control section 11 can allow the tone correcting section 17 to perform tone correction at the point when the print output of one copy is complete in a case where the number of sheets of paper which compose one copy is a predetermined threshold value (first threshold value) or less, and the value counted with the number of sheets of paper which compose the next copy, in other words, the number of sheets of paper which compose two copies is the first threshold value or more and a predetermined threshold value (second threshold value) larger than the first threshold value or more. For example, when the first threshold value is set to 500 [sheets] and the second threshold value is set to 700 [sheets], and the number of sheets which compose one copy is 450 sheets, although the print output when one copy is complete is the first threshold value or less, the value counted with the next copy is 900 [sheets], and the number exceeds the first threshold value of 500 [sheets] and the second threshold value of 700 [sheets]. In this case, the control section 11 allows the tone correction to be performed at the point when the print of one copy is complete. With this, the variation between pages between one copy and the next copy can be reduced.

Regarding the printed amount of print output, when the number of sheets of paper which compose one copy is less than the predetermined printed amount (first printed amount) and the value counted with the printed amount of the next copy, in other words, the printed amount composing two copies is a first printed amount or more and a predetermined printed amount (second printed amount) larger than the first printed amount or more, the control section 11 can allow the tone correcting section 17 to perform the tone correction when the print output of one copy is complete.

When the number of sheets of paper which compose one copy exceeds a first threshold value, in addition to when the print output of one copy is complete, the control section 11 further allows the tone correcting section 17 to perform the tone correction when the forming of the image on a predetermined number of sheets of paper which is the first threshold value or lower is complete during print output of one copy. Here, it is preferable that the control section 11 allows the tone correcting section 17 to perform tone correction each time image forming on the number of sheets of paper where the number of sheets of paper which compose one copy is divided substantially evenly to a number of sheets of paper which is a first threshold value or less is complete.

When the control section 11 divides the number of sheets of paper which compose one copy evenly to a number of sheets which is a first threshold value or less, it is preferable that the control section 11 evenly divides to a divided number which is the minimum number necessary in order to divide the number of sheets of paper which compose one copy to an even number of sheets which is a first threshold value or less. For example, when 500 [sheets] is set as the first threshold value and the number of sheets of paper which compose one copy is 600 [sheets], the control section 11 allows the tone correcting section 17 to perform tone correction at the point when 300 [sheets] among the print output of one copy is complete. When 500 [sheets] is set as the first threshold value, and the number of sheets of paper which compose one copy is 1200 [sheets], the control section 11 allows the tone correcting section 17 to perform tone correction at the timing at the point when 400 [sheets] is complete and at the point when 800 [sheets] is complete among the print output of one copy.

The above described example describes when the number of sheets of paper which compose one copy can be divided to a number of sheets which is a first threshold value or less, however, when the number of sheets of paper which compose one copy cannot be divided to a number of sheets of paper which is a first threshold or less, the difference in timing of performing the tone correction which occurs due to the extra number can be arbitrarily adjusted.

Moreover, other than the first threshold value, a different third threshold value can be set, and in addition to when the print output of one copy is complete as above, the tone correction by the tone correcting section 17 can be further performed at the point when the forming of the image on a predetermined number of sheets of paper which is the third threshold value or less during the print output of one copy when the number of sheets of one copy exceeds the first threshold value. In this case, it is preferable that the control section 11 allows the tone correcting section 17 to perform tone correction each time forming an image on a number of sheets of paper where the number of sheets of paper which compose one copy is divided evenly to a number of sheets of paper which is the third threshold value or less is complete.

For example, when the first threshold value is set to 500 [sheets] and the third threshold value is set to 400 [sheets] and one copy is 1400 [sheets], the control section 11 allows the tone correction to be performed at the point when 350 [sheets], 700 [sheets] and 1050 [sheets] are complete.

The first threshold value, the second threshold value and the third threshold value and the first printed amount and the second printed amount can be arbitrarily set. However, for example, it is preferable that the value is a predetermined value which is a number of sheets of paper or printed amount when tone correction is necessary or less, the value obtained based on “measured result of difference of output density value in advancing of print output” obtained empirically from operation record of the image processing apparatus.

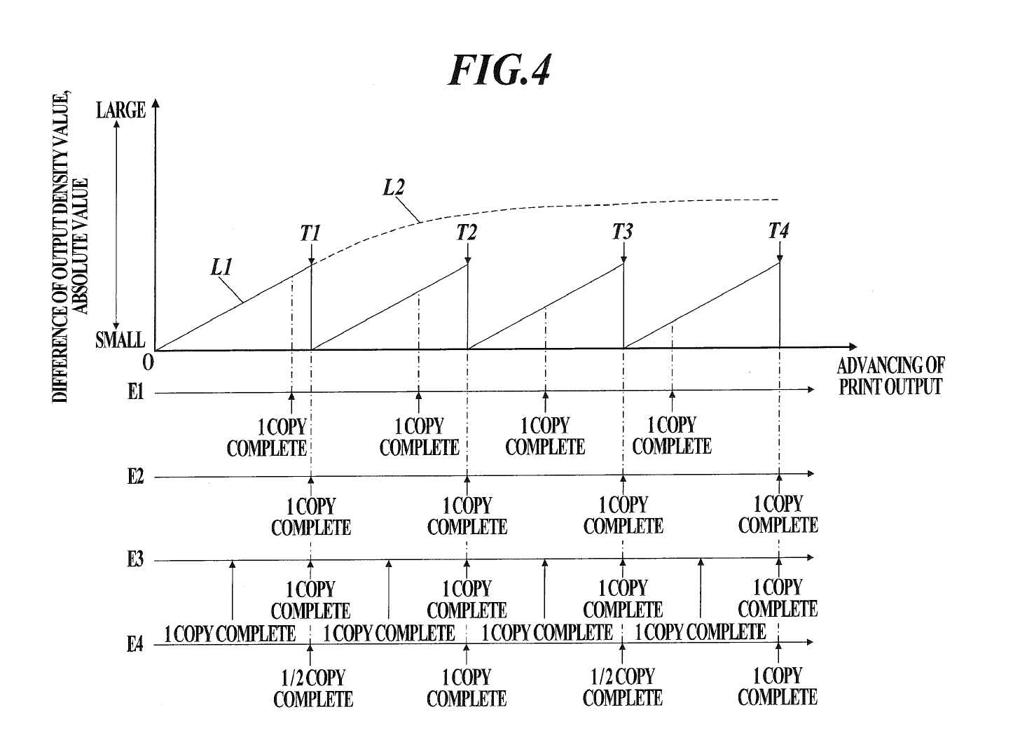

FIG. 4 is used to describe corresponding relation between difference of output density value and timing of tone correction. In the graph shown in FIG. 4, the vertical axis direction indicates the difference of the output density value and the horizontal axis indicates the advancing of the print output.

As shown in line segment L1 of FIG. 4, as print output is performed, the output density value gradually differs from the density value (origin point O shown in FIG. 4) determined when print starts and the difference amount becomes larger.

The control section 11 allows the tone correcting section 17 to perform tone correction at the timing of T1 shown in FIG. 4. With this, the output density value becomes substantially the same as the output density value when print starts.

After tone correction, the difference of output density value occurs again as the print output advances. As shown in the timing T2 to T4 indicated by FIG. 4, the control section 11 performs the tone correction at a predetermined timing to correct the difference of output density value.

In print output of a unit of copies, if timing of tone correction does not consider completing print output of one copy, for example, timing as shown on E1 of FIG. 4, the output density value of each copy becomes different. When such tone correction is performed, variation occurs among each copy of the print output result, specifically the visual image quality (color, etc.) of the front cover (first page) and the print output result becomes a result in which quality is different among copies.

The control section 11 allows the tone correcting section to perform tone correction each time print output of a predetermined number of copies is complete.

For example, as shown on E2 of FIG. 4, by performing tone correction each time print output of one copy is complete, the output density value of each section in the print output in a unit of copies can be made substantially the same, the output density value of each copy in print output in a unit of copies can be stabilized, and quality of print output when print output is performed in a unit of copies can be favorably maintained.

The printed amount in print output of one copy changes according to content of image data. Therefore, when the number of sheets of paper which compose one copy is less than the first threshold value, print output may be performed in an amount equal to or larger than the print output amount when tone correction is necessary depending on the content of image data. Therefore, by performing count and judgment for both number of sheets of paper and printed amount, the timing when tone correction is necessary can be suitably judged.

When the number of sheets of paper which compose one copy or the printed amount is small compared to the print output amount when tone correction is necessary, and the tone correction is performed each time print output of one copy is complete, the productivity of the image forming apparatus 1 may reduce. This is because, when the number of sheets of paper which compose one copy or the printed amount is very small, the difference of output density value is not large or hardly occurs by merely performing print output of one copy, and tone correction is not always necessary. If tone correction is performed in such timing, the advancing of print output is temporarily paused when processing of tone correction is performed, and progress of print output is interrupted.

Therefore, by performing tone correction when print output is complete for each number of copies when the number of sheets of paper of print output is the first threshold value or more or for each number of copies when the printed amount necessary for print output is the first printed amount or more, maintaining the output quality by stabilizing the output density value of the print output in a unit of copies and enhancing the productivity of the image forming apparatus 1 can both be achieved. E3 of FIG. 4 shows an example when tone correction is performed when two copies of print output is complete, and the same can be said for three copies or more.

Moreover, even when the number of sheets of paper which compose one copy is less than the first threshold value, when the number of sheets of paper which compose two copies is the first threshold value or more and the second threshold value which is larger than the first threshold value or more, the tone correction can be performed at the point when the print output of one copy is complete. With this, maintaining the quality of the print output by stabilizing the output density value of the print output in a unit of copies and enhancing the productivity of the image forming apparatus 1 can both be favorably achieved.

The timing control of performing tone correction based on the first printed amount and the second printed amount regarding the printed amount is similar to the timing control of performing tone correction based on the first threshold value and the second threshold value.

When the number of sheets of paper which compose one copy or the printed amount is very large compared to the print output amount when tone correction is necessary, if the timing of tone correction is when print output of one copy is complete, the difference of output density value which occurs during print output of one copy may be too large (for example, dotted line L2 shown in FIG. 4, etc.).

Therefore, when the number of sheets of paper which compose one copy is the number of sheets of the first threshold value or more, the tone correction is performed at the point when forming of an image on a predetermined number of sheets of paper which is the first threshold value or less is complete during the print output of one copy. Therefore, the difference of the output density value becoming too large during advancing of the print output of one copy can be suitably suppressed and the output density value can be stabilized. Consequently, the quality of print output in print output in a unit of copies can be favorably maintained.

Here, by allowing the tone correcting section 17 to perform tone correction when the forming of the image on the paper of the number of sheets where the number of sheets of paper which compose one copy is divided evenly to a number of sheets which is the first threshold value or less is complete, the range of change of the output density value which occurs during print output of one copy can be set within a small range. Therefore, the output density value can be stabilized and the quality of print output can be favorably maintained. E4 of FIG. 4 shows an example when tone correction is performed in the timing where the number of sheets of paper which compose one copy is divided in two, however, the same can be said for dividing in three or more.

Here, when the third threshold value is set, by allowing the tone correcting section 17 to perform tone correction when forming of an image on the paper of the number of sheets where the number of sheets of paper which compose one copy is divided substantially evenly in a number of sheets which is the third threshold value or less is complete, timing of performing tone correction can be determined based on the third threshold value which does not rely on the first threshold value, and the range of change of the output density value which occurs during print output of one copy can be set within a small range. Therefore, the output density value can be stabilized and the quality of print output can be favorably maintained.

Below, the flow of the timing control of the tone correction of the control section 11 is described using the flowchart.

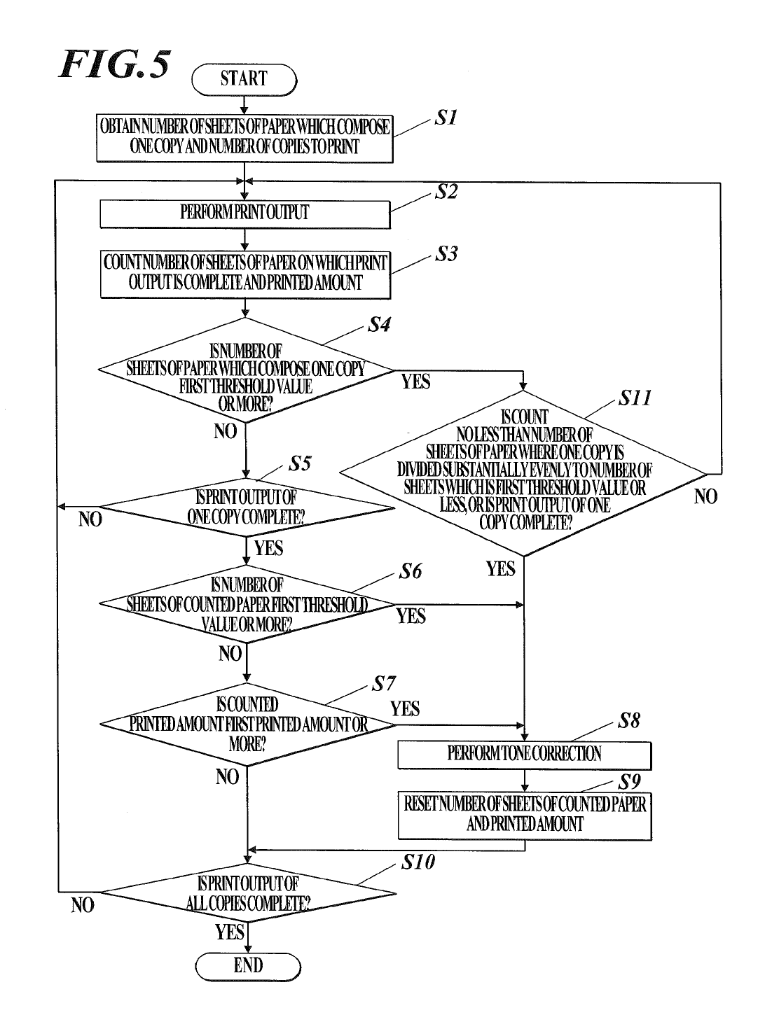

FIG. 5 is a flowchart showing a flow of timing control of the tone correction by the control section 11 when setting of the second threshold, the third threshold and the second printed amount is not performed.

When the control of the print output in a unit of copies is performed, the control section 11 obtains the number of sheets of paper which compose one copy and the number of copies of print output (step S1). Next, the control section 11 controls the operation of each section of the image forming apparatus 1 to perform image forming (print output) based on image data (step S2). The control section 11 counts the measured result of the number of sheets of paper on which print output is complete and the printed amount in print output (step S3).

Next, the control section 11 judges whether the number of sheets of paper which compose one copy is the first threshold value or more (step S4).

When the number of sheets of paper which compose one copy is not the first threshold value or more (step S4: NO), the control section 11 judges whether the print output of one copy is complete (step S5). When the print output of one copy is not complete (step S5: NO), the processing returns to step S2.

When the print output of one copy is complete (step S5: YES), the control section 11 judges whether the number of sheets of paper counted by the processing of step S2 is the first threshold value or more (step S6). When the number of sheets of counted paper is less than the first threshold value (step S6: NO), the control section 11 judges whether the printed amount counted by the processing of step S2 is the first printed amount or more (step S7).

When the number of sheets of counted paper is the first threshold value or more (step S6: YES) or the counted printed amount is the first printed amount or more (step S7: YES), the control section 11 allows the tone correcting section 17 to perform tone correction (step S8). Then, after the processing of step S8, the control section 11 resets the number of sheets of paper and the printed amount counted in the processing of step S3 (step S9).

After the processing of step S9 or when the printed amount counted in the judgment of step S7 is less than the first printed amount (step S7: NO), the control section 11 judges whether the print output of the number of copies (all copies) obtained in the processing of step S1 is complete (step S10). When the print output of all copies is not complete (step S10: NO), the processing returns to the processing of step S2.

When the print output of all copies is complete, the control section 11 ends the print output.

In the judgment of step S4, when the number of sheets of paper which compose one copy is the first threshold value or more (step S4: YES), the control section 11 judges whether the number of sheets of the counted paper is no less than the number of sheets of paper where the number of sheets of paper which compose one copy is divided evenly to a number of sheets which is the first threshold value or less or the print output of one copy is complete (step S11).

In the judgment of step S11, when at least either one of the condition of the number of sheets of the counted paper is no less than the number of sheets of paper where the number of sheets of paper which compose one copy is divided evenly to a number of sheets which is the first threshold value or less or the print output of one copy is complete (step S11: YES), the processing advances to the processing of step S8. When the number of sheets of the counted paper is less than the number of sheets of paper where the number of sheets of paper which compose one copy is divided evenly to a number of sheets which is the first threshold value or less and the print output of one copy is not complete (step S11: NO), the processing returns to step S2.

In the flowchart and the description of FIG. 5, the order of the judgment of step S6 and S7 are not fixed, and the order of performing the judgment based on the number of sheets of paper and the judgment based on the printed amount can be switched.

Moreover, judgment of “complete printing of one copy” in the judgment of step S5 and S11 is judgment performed separately from judgment based on the number of sheets of counted paper.

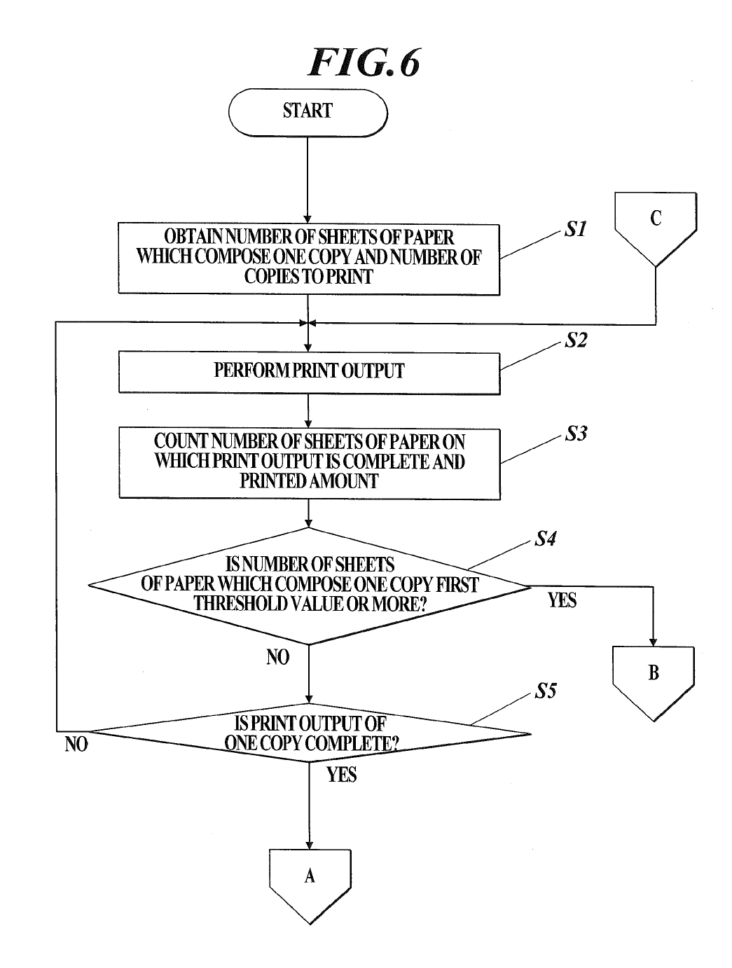

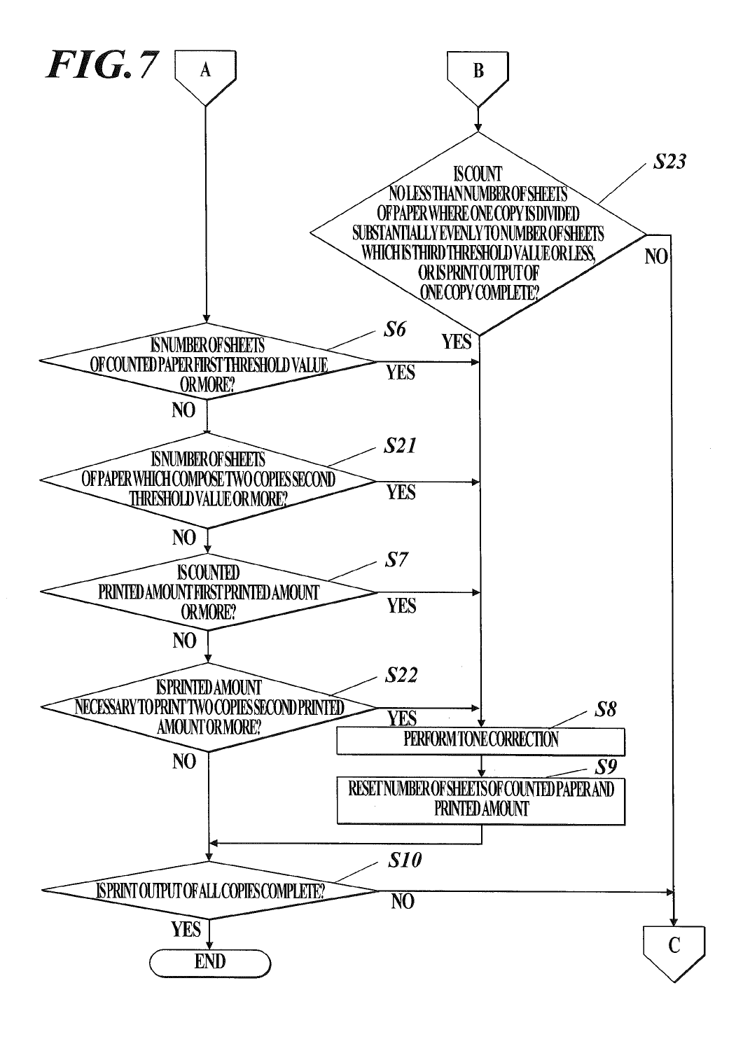

FIG. 6 and FIG. 7 are flowcharts showing a flow of timing control of tone correction by the control section 11 when the second threshold value, the third threshold value and the second printed amount are set. The same step number is applied to the processing similar to FIG. 5 and the description is omitted.

In the judgment of step S6, when the number of sheets of counted paper is less than the first threshold value (step S6: NO), the control section 11 judges whether the number of sheets of paper which compose two copies is the second threshold value or more (step S21). In step S21, the control section 11 obtains the number of sheets of paper which compose two copies by, for example, a value where the number of sheets of paper counted at point of completing print of one copy is doubled and makes a judgment.

In the judgment of step S21, when the number of sheets of paper which compose two copies is the second threshold value or more (step S21: YES), the processing advances to the processing of step S8 and the tone correction is performed. In the judgment of step S21, when the number of sheets of paper which compose two copies is not the second threshold value or more, the processing advances to step S7.

When the printed amount counted in the judgment of step S7 is less than the first printed amount (step S7: NO), the control section 11 judges whether the printed amount necessary for print output of two copies is the second printed amount or more (step S22). In step S22, the control section 11 obtains the printed amount necessary for print output of two copies by, for example, a value where the printed amount counted at point of completing print of one copy is doubled and makes a judgment.

In the judgment of step S22, when the printed amount necessary for print output of two copies is the second printed amount or more (step S22: YES), the processing advances to the processing of step S8 and tone correction is performed. In the judgment of step S22, when the printed amount necessary for print output of two copies is not the second printed amount or more, the processing advances to the processing of step S10.

In the judging of step S4, when the number of sheets of paper which compose one copy is the first threshold value or more (step S4: YES), the control section 11 judges whether number of sheets of the counted paper is the number of sheets of paper where the number of sheets of paper which compose one copy is divided evenly to a number of sheets which is the third threshold value or less or the print output of one copy is complete (step S23).

In the judgment of step S23, when the condition of at least either one of the number of sheets of counted paper is no less than the number of sheets of paper where the number of sheets of paper which compose one copy is divided evenly to a number of sheets which is the third threshold value or less, or the print output of one copy is complete is satisfied (step S23: YES), the processing advances to step S8. When the number of sheets of counted paper is less than the number of sheets of paper where the number of sheets of paper which compose one copy is divided evenly to a number of sheets which is the third threshold value or less and the print output of one copy is not complete (step S23: NO), the processing returns to the processing of step S2.

In the flowchart and the description of FIG. 5, the order of step S6, step S21, step S7 and step S22 are not fixed and the order of performing the judgment based on the number of sheets of paper and the judgment based on the printed amount can be switched.

Moreover, judgment of “complete printing of one copy” in the judgment of step S5 and step S23 is judgment performed separately from judgment based on the number of sheets of counted paper.

Further, only some of the second threshold value, the third threshold value and the second printed amount may be set. When the second threshold value is set, the processing of step S21 is performed, when the third threshold value is set, the processing of step S23 is performed instead of the processing of step S11 and when the second printed amount is set, the processing of step S22 is performed.

According to the present embodiment, during print output in a unit of copies, timing of performing tone correction is based on timing of print output in a unit of one copy completing. With this, the output density value of each copy can be stabilized when print output is performed in a unit of copies and quality of print output when print output is performed in a unit of copies can be favorably maintained.

For example, by performing tone correction each time print output of one copy is complete, the output density value of each copy when print output is performed in a unit of copies can be made substantially the same, the output density value of each copy can be stabilized when print output is performed in a unit of copies and quality of print output when print output is performed in a unit of copies can be favorably maintained.

Regarding two or more copies, by performing tone correction when print is complete in a unit of copies, the variation of timing of performing tone correction on sheets of paper which compose one copy can be drastically decreased, and compared to when there is no relation between the number of sheets of paper composing one copy and the timing of performing tone correction, the output density value of each copy when print output is performed in a unit of copies can be highly stabilized. Moreover, tone and color of a same page among each copy can be made even and variation in image quality and quality among each copy can be reduced.

When the number of sheets of paper necessary to perform print output of a predetermined number of copies is a first threshold value or more, the control section 11 allows the tone correcting section 17 to perform tone correction.

With this, when the number of sheets of paper which compose one copy or the printed amount is small compared to the print output amount when tone correction is necessary, reduction of productivity of the image forming apparatus 1 by performing tone correction each time print output of one copy is complete can be prevented. Therefore, both the maintaining of quality of print output by stabilizing the output density value when print output is performed in a unit of copies and enhancing productivity of the image forming apparatus 1 can be achieved.

When the number of sheets of paper necessary to perform print output of one copy is less than the first threshold value and the number of sheets of paper necessary to perform print output of two copies is a second threshold value or more, tone correction is performed by the correcting section each time print output of one copy is complete.

With this, not only the number of sheets of paper necessary for print output of one copy but also the number of sheets of paper necessary for print output of two copies can be considered to control timing of performing tone correction and flexible timing control of performing tone correction can be realized.

When the printed amount necessary for print output of a predetermined number of copies is a first printed amount or more, the control section 11 allows the tone correcting section 17 to perform tone corrections.

With this, when the number of sheets of paper which compose one copy or the printed amount is small compared to the print output amount when tone correction is necessary, reduction of productivity of the image forming apparatus 1 by performing tone correction each time print output of one copy is complete can be prevented. Therefore, both the maintaining of quality of print output by stabilizing the output density value when print output is performed in a unit of copies and enhancing productivity of the image forming apparatus 1 can be achieved.

When the printed amount necessary for print output of one copy is less than the first printed amount and the printed amount necessary for print output of two copies is a second printed amount or more, tone correction is performed by the correcting section each time print output of one copy is complete.

With this, not only the printed amount necessary for print output of one copy but also the printed amount necessary for print output of two copies can be considered to control timing of performing tone correction and flexible timing control of performing tone correction can be realized.

When the number of sheets of paper which compose one copy is a number of sheets of a first threshold value or more, tone correction is performed at a point where forming of an image on a predetermined number of sheets of paper which is a first threshold value or less is complete during print output of one copy. Therefore, the difference of the output density value becoming too large while advancing print output of one copy can be suitably prevented and the output density value can be stabilized. Consequently, quality of print output when print output is performed in a unit of copies can be favorably maintained.

When the tone correction is performed at the point when forming of an image on a predetermined number of sheets of paper which is a first threshold value or less is complete, by allowing the tone correcting section 17 to perform the tone correction when the forming of the image on the paper of a number of sheets where the number of sheets of paper which compose one copy is divided equally to a number of sheets which is a first threshold value or less is complete, the range of change of the output density value which occurs during print output of one copy can be set within a small range. Therefore, the output density value can be stabilized and the quality of print output can be favorably maintained.

When the tone correction is performed at the point when forming of an image on a predetermined number of sheets of paper which is a first threshold value or less is complete, by allowing the tone correcting section 17 to perform tone correction when forming of an image on a number of sheets of paper where the number of sheets of paper which compose one copy is divided equally to a number of sheets which is a third threshold value or less is complete, the range of change of the output density value which occurs during print output of one copy can be set within a small range. Therefore, the output density value can be stabilized and the quality of print output can be favorably maintained. By using the third threshold value, the timing of performing tone correction during print output of one copy can be controlled arbitrarily without depending on the first threshold value, and therefore flexible timing control of performing tone correction can be realized.

Although various exemplary embodiments have been shown and described, all points of the embodiment disclosed here is merely an example and the invention is not limited to the embodiments shown. Therefore, the scope of the invention is intended to be limited solely by the scope of the claims that follow and not by the above explanation, and it is intended that the present invention covers modifications and variations that come within the scope of the appended claims and their equivalents.

For example, the tone correction can be performed by the tone correcting section 17 each time print output of one copy is complete. In this case, when the number of sheets of paper which compose one copy is a number of sheets which is a second threshold value or more, the tone correction can be performed at a point where the forming of the image on a predetermined number of sheets of paper which is the second threshold value or less is complete during the print output of one copy. When the tone correction is performed at a point when the forming of the image on the predetermined number of sheets of paper which is the second threshold value or less is complete, the tone correction by the tone correcting section 17 can be performed when the forming of the image on the paper of the number of sheets of paper where the number of sheets of paper which compose one copy is divided evenly to a number of sheets of paper which is the second threshold value or less is complete.

The judgment of performing tone correction based on the number of sheets of paper regarding print output and the printed amount can be judgment based on either one of the number of sheets of paper or the printed amount or the tone correction can be performed when both conditions are satisfied when both are employed. The processing of performing tone correction at the point when the forming of the image on a predetermined number of sheets of paper which is the second threshold value or less is complete during print output of one copy and judgment regarding the above processing can be omitted.

The specific configuration and the specific operation of the image forming apparatus 1 of the second embodiment can be suitably changed without leaving the scope of the present invention.

According to an aspect of the preferred embodiments of the present invention, there is provided an image forming apparatus which forms an image on paper, the image forming apparatus including:

an image forming section which forms the image on the paper;

a correcting section which corrects tone of the image formed by the image forming section; and

a control section which manages forming the image on a predetermined number of sheets of paper as print output of one unit, and which allows the correcting section to correct tone each time print output of the predetermined number of units is complete.

Consequently, the output density value of each copy can be stabilized when print output is performed in a unit of copies and quality of print output when print output is performed in a unit of copies can be favorably maintained.

Preferably, in the image forming apparatus,

the predetermined number of units is a number of units in which a number of sheets of paper necessary for print output of the predetermined number of units is a first threshold value or more.

Consequently, when the number of sheets of paper which compose one copy or the printed amount is small compared to the print output amount when tone correction is necessary, reduction of productivity of the image forming apparatus 1 by performing tone correction each time print output of one copy is complete can be prevented. Therefore, both the maintaining of quality of print output by stabilizing the output density value when print output is performed in a unit of copies and enhancing productivity of the image forming apparatus 1 can be achieved.

Preferably, in the image forming apparatus,

the control section allows the correcting section to perform tone correction each time print output of one unit is complete when a number of sheets of paper necessary for print output of one unit is less than the first threshold value, and the number of sheets of paper necessary for print output of two units is no less than a second threshold value which is larger than the first threshold value.

Consequently, not only the number of sheets of paper necessary for print output of one copy but also the number of sheets of paper necessary for print output of two copies can be considered to control timing of performing tone correction and flexible timing control of performing tone correction can be realized.

Preferably, in the image forming apparatus,

the predetermined number of units is a number of units in which a printed amount necessary for print output of the predetermined number of units is a first printed amount or more.

Consequently, when the number of sheets of paper which compose one copy or the printed amount is small compared to the print output amount when tone correction is necessary, reduction of productivity of the image forming apparatus 1 by performing tone correction each time print output of one copy is complete can be prevented. Therefore, both the maintaining of quality of print output by stabilizing the output density value when print output is performed in a unit of copies and enhancing productivity of the image forming apparatus 1 can be achieved.

Preferably, in the image forming apparatus,

the control section allows the correcting section to perform tone correction each time print output of one unit is complete when a printed amount necessary for print output of one unit is less than the first printed amount, and the printed amount necessary for print output of two units is no less than a second threshold value which is larger than the first threshold value.

Consequently, not only the printed amount necessary for print output of one copy but also the printed amount necessary for print output of two copies can be considered to control timing of performing tone correction and flexible timing control of performing tone correction can be realized.

Preferably, in the image forming apparatus,

the control section allows the correcting section to perform tone correction each time print output of one unit is complete.

Preferably, in the image forming apparatus,

the control section allows the correcting section to perform tone correction when forming of an image on a predetermined number of sheets of paper which is the first threshold value or less is complete during print output of one unit in addition to when print output of one unit is complete in a case where the predetermined number of sheets is a number of sheets of the first threshold value or more.

Consequently, the difference of the output density value becoming too large while advancing print output of one copy can be suitably prevented and the output density value can be stabilized. Consequently, quality of print output when print output is performed in a unit of copies can be favorably maintained.

Preferably, in the image forming apparatus,

the control section allows the correcting section to perform tone correction each time forming of an image on paper of a number of sheets where a predetermined number of sheets which compose one unit is divided evenly to a number of sheets which is the first threshold value or less is complete during print output of one unit.

Consequently, the range of change of the output density value which occurs during print output of one copy can be set within a small range. Therefore, the output density value can be stabilized and the quality of print output can be favorably maintained.

Preferably, in the image forming apparatus,

the control section allows the correcting section to perform tone correction each time forming of an image on paper of a number of sheets where a predetermined number of sheets which compose one unit is divided evenly to a number of sheets which is the third threshold value or less is complete during print output of one unit.

Consequently, the range of change of the output density value which occurs during print output of one copy can be set within a small range. Therefore, the output density value can be stabilized and the quality of print output can be favorably maintained. By using the third threshold value, the timing of performing tone correction during print output of one copy can be controlled arbitrarily without depending on the first threshold value, and therefore flexible timing control of performing tone correction can be realized.

According to another aspect of the preferred embodiments of the present invention, there is provided a tone correction method of an image forming apparatus, the method including:

a step in which an image forming section forms the image on the paper;

a step in which a correcting section corrects tone of the image; and

a step in which a control section manages forming the image on a predetermined number of sheets of paper as print output of one unit, and allows the correcting section to correct tone each time print output of the predetermined number of units is complete.

Consequently, the output density value of each copy can be stabilized when print output is performed in a unit of copies and quality of print output when print output is performed in a unit of copies can be favorably maintained.

Preferably, in the tone correction method of the image forming apparatus,

the predetermined number of units is a number of units in which a number of sheets of paper necessary for print output of the predetermined number of units is a first threshold value or more.

Consequently, when the number of sheets of paper which compose one copy or the printed amount is small compared to the print output amount when tone correction is necessary, reduction of productivity of the image forming apparatus 1 by performing tone correction each time print output of one copy is complete can be prevented. Therefore, both the maintaining of quality of print output by stabilizing the output density value when print output is performed in a unit of copies and enhancing productivity of the image forming apparatus 1 can be achieved.

Preferably, in the tone correction method of the image forming apparatus,

the control section allows the correcting section to perform tone correction each time print output of one unit is complete when a number of sheets of paper necessary for print output of one unit is less than the first threshold value, and the number of sheets of paper necessary for print output of two units is no less than a second threshold value which is larger than the first threshold value.

Consequently, not only the number of sheets of paper necessary for print output of one copy but also the number of sheets of paper necessary for print output of two copies can be considered to control timing of performing tone correction and flexible timing control of performing tone correction can be realized.

Preferably, in the tone correction method of the image forming apparatus,

the predetermined number of units is a number of units in which a printed amount necessary for print output of the predetermined number of units is a first printed amount or more.

Consequently, when the printed amount is small compared to the print output amount when tone correction is necessary, reduction of productivity of the image forming apparatus 1 by performing tone correction each time print output of one copy is complete can be prevented. Therefore, both the maintaining of quality of print output by stabilizing the output density value when print output is performed in a unit of copies and enhancing productivity of the image forming apparatus 1 can be achieved.

Preferably, in the tone correction method of the image forming apparatus,

the control section allows the correcting section to perform tone correction each time print output of one unit is complete when a printed amount necessary for print output of one unit is less than the first printed amount, and the printed amount necessary for print output of two units is no less than a second threshold value which is larger than the first threshold value.

Consequently, not only the printed amount necessary for print output of one copy but also the printed amount necessary for print output of two copies can be considered to control timing of performing tone correction and flexible timing control of performing tone correction can be realized.

Preferably, in the tone correction method of the image forming apparatus,

the control section allows the correcting section to perform tone correction each time print output of one unit is complete.

Preferably, in the tone correction method of the image forming apparatus,

the control section allows the correcting section to perform tone correction when forming of an image on a predetermined number of sheets of paper which is the first threshold value or less is complete during print output of one unit in addition to when print output of one unit is complete in a case where the predetermined number of sheets is a number of sheets of the first threshold value or more.

Consequently, the difference of the output density value becoming too large while advancing print output of one copy can be suitably prevented and the output density value can be stabilized. Consequently, quality of print output when print output is performed in a unit of copies can be favorably maintained.

Preferably, in the tone correction method of the image forming apparatus,

the control section allows the correcting section to perform tone correction each time forming of an image on paper of a number of sheets where a predetermined number of sheets which compose one unit is divided evenly to a number of sheets which is the first threshold value or less is complete during print output of one unit.

Consequently, the range of change of the output density value which occurs during print output of one copy can be set within a small range. Therefore, the output density value can be stabilized and the quality of print output can be favorably maintained.

Preferably, in the tone correction method of the image forming apparatus,

the control section allows the correcting section to perform tone correction each time forming of an image on paper of a number of sheets where a predetermined number of sheets which compose one unit is divided evenly to a number of sheets which is the third threshold value or less is complete during print output of one unit.

Consequently, the range of change of the output density value which occurs during print output of one copy can be set within a small range. Therefore, the output density value can be stabilized and the quality of print output can be favorably maintained. By using the third threshold value, the timing of performing tone correction during print output of one copy can be controlled arbitrarily without depending on the first threshold value, and therefore flexible timing control of performing tone correction can be realized.

The present application is based on Japanese Patent Application No. 2010-252404 filed on Nov. 11, 2010 to the Japanese Patent Office, which shall be a basis for correcting mistranslations.

What is claimed is:

1. An image forming apparatus which forms an image on paper, the image forming apparatus comprising:
an image forming section which forms the image on the paper;
a correcting section which corrects tone of the image formed by the image forming section; and
a control section which manages forming the image on a predetermined number of sheets of paper as print output of one unit, and which allows the correcting section to correct tone each time print output of the predetermined number of units is complete.

2. The image forming apparatus of claim 1,
wherein the predetermined number of units is a number of units in which a number of sheets of paper necessary for print output of the predetermined number of units is a first threshold value or more.

3. The image forming apparatus of claim 2,
wherein the control section allows the correcting section to perform tone correction each time print output of one unit is complete when a number of sheets of paper necessary for print output of one unit is less than the first threshold value, and the number of sheets of paper necessary for print output of two units is no less than a second threshold value which is larger than the first threshold value.

4. The image forming apparatus of claim 1,
wherein the predetermined number of units is a number of units in which a printed amount necessary for print output of the predetermined number of units is a first printed amount or more.

5. The image forming apparatus of claim 4,
wherein the control section allows the correcting section to perform tone correction each time print output of one unit is complete when a printed amount necessary for print output of one unit is less than the first printed amount, and the printed amount necessary for print output of two units is no less than a second threshold value which is larger than the first threshold value.

6. The image forming apparatus of claim 1,
wherein the control section allows the correcting section to perform tone correction each time print output of one unit is complete.

7. The image forming apparatus of claim 6,
wherein the control section allows the correcting section to perform tone correction when forming of an image on a predetermined number of sheets of paper which is the first threshold value or less is complete during print output of one unit in addition to when print output of one unit is complete in a case where the predetermined number of sheets is a number of sheets of the first threshold value or more.

8. The image forming apparatus of claim 7,
wherein the control section allows the correcting section to perform tone correction each time forming of an image on paper of a number of sheets where a predetermined number of sheets which compose one unit is divided evenly to a number of sheets which is the first threshold value or less is complete during print output of one unit.

9. The image forming apparatus of claim 7,
wherein the control section allows the correcting section to perform tone correction each time forming of an image on paper of a number of sheets where a predetermined number of sheets which compose one unit is divided evenly to a number of sheets which is the third threshold value or less is complete during print output of one unit.

10. A tone correction method of an image forming apparatus, the method comprising:
a step in which an image forming section forms the image on the paper;
a step in which a correcting section corrects tone of the image; and
a step in which a control section manages forming the image on a predetermined number of sheets of paper as print output of one unit, and allows the correcting section to correct tone each time print output of the predetermined number of units is complete.

11. The tone correction method of the image forming apparatus of claim 10,
wherein the predetermined number of units is a number of units in which a number of sheets of paper necessary for print output of the predetermined number of units is a first threshold value or more.

12. The tone correction method of the image forming apparatus of claim 11,
wherein the control section allows the correcting section to perform tone correction each time print output of one unit is complete when a number of sheets of paper necessary for print output of one unit is less than the first threshold value, and the number of sheets of paper necessary for print output of two units is no less than a second threshold value which is larger than the first threshold value.

13. The tone correction method of the image forming apparatus of claim 10,
wherein the predetermined number of units is a number of units in which a printed amount necessary for print output of the predetermined number of units is a first printed amount or more.

14. The tone correction method of the image forming apparatus of claim 13,
wherein the control section allows the correcting section to perform tone correction each time print output of one unit is complete when a printed amount necessary for print output of one unit is less than the first printed amount, and the printed amount necessary for print output of two units is no less than a second threshold value which is larger than the first threshold value.

15. The tone correction method of the image forming apparatus of claim 10,
wherein the control section allows the correcting section to perform tone correction each time print output of one unit is complete.

16. The tone correction method of the image forming apparatus of claim 15,
wherein the control section allows the correcting section to perform tone correction when forming of an image on a predetermined number of sheets of paper which is the first threshold value or less is complete during print output of one unit in addition to when print output of one unit is complete in a case where the predetermined number of sheets is a number of sheets of the first threshold value or more.

17. The tone correction method of the image forming apparatus of claim 16,
wherein the control section allows the correcting section to perform tone correction each time forming of an image on paper of a number of sheets where a predetermined number of sheets which compose one unit is divided evenly to a number of sheets which is the first threshold value or less is complete during print output of one unit.

18. The tone correction method of the image forming apparatus of claim 16,
wherein the control section allows the correcting section to perform tone correction each time forming of an image on paper of a number of sheets where a predetermined number of sheets which compose one unit is divided evenly to a number of sheets which is the third threshold value or less is complete during print output of one unit.
